(19) United States
(12) Patent Application Publication
(10) Pub. No.: US 2007/0286180 A1
(43) Pub. Date: Dec. 13, 2007

(54) CONVERGED CALL CENTER

(75) Inventors: Brian Marquette, Longmont, CO (US); Michael Clark, Boulder, CO (US); Charles Corfield, Boulder, CO (US); Christopher Kramp, Boulder, CO (US)

Correspondence Address: HOLLAND & HART, LLP, P.O BOX 8749, DENVER, CO, 80201, US

(73) Assignee: SandCherry, Inc., Boulder, CO (US)

(21) Appl. No.: 11/760,552

(22) Filed: Jun. 8, 2007

Related U.S. Application Data
(60) Provisional application No. 60/804,241, filed on Jun. 8, 2006.

(51) Int. Cl. H04L 12/66

(52) U.S. Cl. 370/356

(57) ABSTRACT

A converged call center is provided. The converged call center provides a switch connectable to a customer through a telephone network. The switch connects to a converged container comprising a plurality of applications necessary for the call center functionality. The converged container is connected to a voice platform to facilitate communication between the applications, the customer, and a customer service representative.

### RELATED APPLICATIONS

The present application claims priority to U.S. Provisional Application Ser. No. 60/804,241 filed Jun. 8, 2006, titled CONVERGED CALL CENTER, the specification of which is incorporated herein by reference as if set out in full.

### FIELD OF THE INVENTION

The present invention relates to network operations and, more particularly to converged call centers.

### BACKGROUND OF THE INVENTION

A call center is the principal point of service for the customers and employees of many corporations. Originally, call centers handled all calls with live agents. The desire to lower operating costs, improve customer satisfaction, and raise agent productivity has fostered many innovations to help automate the work flow within call centers.

Most call centers have some form of Interactive Voice Response (IVR) to encourage the customer to service himself and save the Call Center operator the expense of agent-service. If the IVR functionality doesn't suffice, the call is placed into a wait queue on an Automatic Call Distributor (ACD), which is a type of switch that matches up waiting customers to available agents. The ACD often plays ‘comfort’ music, or ‘helpful’ messages to the customer until he can be transferred to an agent. When an agent becomes available, a Computer Telephony Integration (CTI) system synchronizes the transfer of the call and any collected data to the agent. The CTI system usually displays a “screen pop” on the agent's desktop with some information on the caller, and may also invoke a new session in the Customer Relationship Management (CRM) application and transfer data from the ACD and/or IVR to the CRM application. A typical call center employs some, or all of the following technologies:

ACD—Automatic Call Distribution

IVR—Interactive Voice Response

CTI—Computer Telephony Integration

CRM—Customer Relationship Management

These technologies have emerged without any standards for interoperability. Their vendor-specific APIs lead to costly integration. When building out a call center, the system-integration expense is typically 50-100+% on top of the cost of the component systems. Thus, it would be desirous to provide a system, method, and apparatus, which reduces or eliminates the integration and associated costs.

### SUMMARY OF THE INVENTION

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIG. 1 is a conceptual diagram of a conventional call center;

FIG. 2 is a conceptual diagram of a call center consistent with the present invention;

FIG. 3 is a sample call flow diagram; and

FIG. 4 is another sample call flow diagram.

### DETAILED DESCRIPTION

The technology of the present application is being described in relation to a call center connectable to a public switched telephone network. One of ordinary skill in the art on reading the disclosure will now recognize that the call center may be connected to other telephony systems, such as, for example, radio system, VoIP systems, or the like. Moreover, the technology of the present application is being explained with reference to exemplary embodiments. The word “exemplary” is used herein to mean “serving as an example, instance, or illustration.” Any embodiment described herein as “exemplary” is not necessarily to be construed as preferred or advantageous over other embodiments. Moreover, unless explicitly stated all embodiments should be considered exemplary.

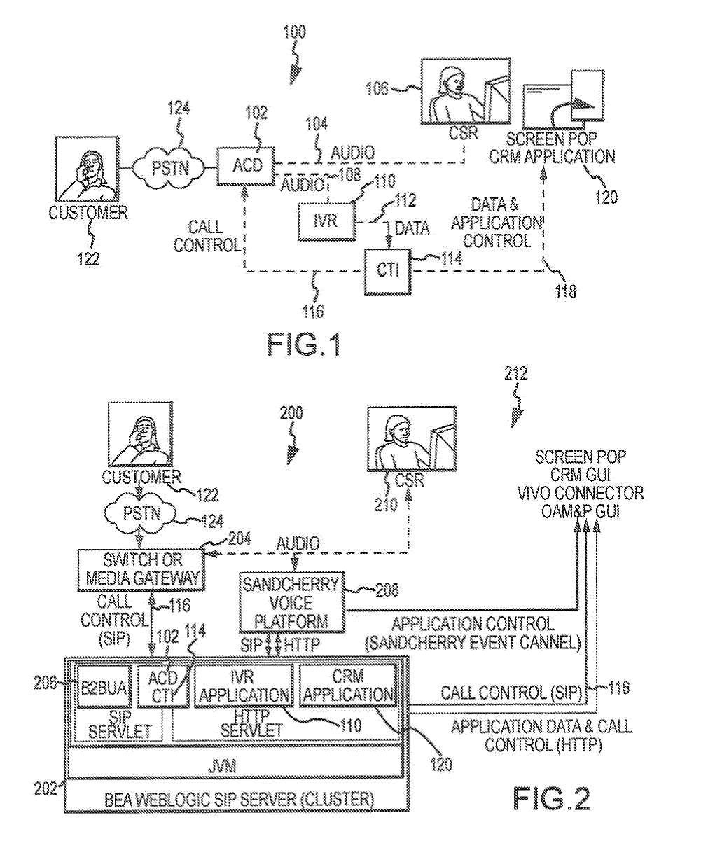

Referring first to FIG. 1 is a conceptual representation of the systems within a call center 100 is shown. The call center 100 includes both voice technologies which lie on the signaling and audio path and terminate at the agent's phone (or headset) and IP-based technologies that support the CRM application, whose graphical user interface (GUI) runs on the agent's processor, such as, for example, a personal computer or the like. To support this, the call center 100 includes, ACD 102 having an audio connection 104 to an agent phone 106. ACD 102 also has an audio connection 108 to IVR 110. Audio connection 104 and 108 may be overlapping, completely separate, or a combination thereof. IVR 110 has a data connection 112 to CTI 114. CTI 114 typically provides call control 116 to ACD 102 and data and application control 118 to an agent's computer 120. Thus, when a customer uses a telephone 122 or the like to call the call center over a conventional network 124, such as, the PSTN shown, the audio, data, and applications necessary for the agent to assist the caller are provided.

Typically, ACD 102, IVR 110, and CTI 114 are stand-alone, proprietary systems from different vendors. In practice, competitive pressures have led the vendors to encroach on each other's turf, so that an IVR system may have some CTI capabilities and vice versa, or an ACD may have built-in IVR capabilities.

The vendors of ACD 102, IVR 110, and CTI 114 systems have made substantial investments to support each other's API's. For example, CTI 114 must communicate with all the different types of ACDs 102 and phone systems to transfer calls from the hold queue to an available agent; and they must access all the different types of IVR 110 to retrieve data for screen-pops. In many instances the collected data cannot be transferred automatically to the CRM application 120, and the agent has to re-type it from the screen-pop, or (worse) has to ask the caller to repeat the information.

Referring now to FIG. 2, a call center 200 is shown. Call center 200 contains the same ACD 102, IVR 110, CTI 114, and CRM application 120 as system 200, but is arranged to function without specific interfaces such that ACD 102 needs to communicate with all available IVRs 110 for example.

As seen in FIG. 2, a SIP/HTTP container 202 is established to host ACD 102, IVR 110, CTI 114, and CRM application 120 as well as the call control 116. These functions, which were previously implemented in separate systems, can now execute in a common environment (a converged container) and have access to each other's data. For convenience, center 200 is described with particular reference to call flow and agent registration.

Center 200 includes a switch 204 or media gateway, as can be found in the art, the SIP/HTTP container 202, which is implemented in a current embodiment as a BEA Weblogic SIP Server including a session initiation protocol (SIP) back-to-back-user-agent 206 (B2BUA as are generally known in the art), a voice platform 208, such as a voice platform available from SandCherry Incorporated, which executes, for example, VoiceXML for ACD 102 and IVR 110. Voice platform 208 may be referred to as SVP 208 Ideally, the agent hand piece is a VoIP enabled device 210, but not necessarily. The agent typically operates a conventional processor 212, such as a personal computer.

For simplicity, and without loss of generality, center 200 will be explained assuming all calls arriving at the center 200 from customer 122 are received by a switch, which supports the appropriate signaling and media transport protocols of the network outside the call center, and SIP signaling with RTP media transport inside the call center. One of skill in the art will understand other arrangements are possible.

When a call arrives at the call center, it is intercepted by switch 204, which issues an invite to container 202. B2BUA 206 running on container 202 accepts the invite and starts a new session (represented in part by call control (SIP) 116, which lasts for the duration of customer's call to the call center 200. Once the call has been accepted it is processed through its various stages by various functional units also running in the same converged container 202. Explaining generally the call flow in terms of ACD 102, IVR 110, CTI 114, CRM application 120, and Agent Transfer functions (not specifically shown on the figure). IVR 110, CTI 114, CRM application 120, and Agent Transfer modules can be thought of as execution assistants for the ACD 102, where the call returns to ACD 102 after each assistant has completed its ask. For example, ACD 102 may deliver an audio signal to IVR 110 for recognition. IVR would send a recognized audio signal back to ACD 102.

ACD 102: The ACD program module moves the call through its logical stages. It issues invites to other modules to perform particular tasks, after which the call returns to the ACD to be moved to the next task. For example, the first task is, typically, to gather information from the caller using IVR. The ACD logic running on container 202 issues a SIP invite to the SVP 208; the invite includes the URL of a VoiceXML script, to SVP 208. The SVP 208 accepts the invite and the ACD program module sets up a media path between the caller and SVP 208 that conducts a dialog with the customer by executing the VoiceXML script.

IVR 110: The IVR program module resides in the converged container 202. The SVP 208 executes the VoiceXML scripts generated by the IVR program module and posts results back to the IVR program. The results are stored in the converged container 202 for later use. If the caller was able to accomplish all his business using the IVR logic, he hangs up and the session is over. However, he may wish to speak to an agent, and he indicates this at some point during the IVR dialog. The IVR program wraps up its work, signals the end of the IVR session to SVP 208, and disconnects the media path to SVP 208. The IVR logic hands control back to the ACD program module, which queues up the call for the next available agent.

Call Queuing: The ACD program module examines its list of available agents. If there is one, the session then moves to the CTI logic to transfer the call and pertinent user data, otherwise, the ACD logic queues the call and waits for an agent to become available (or for the caller to hang up). While a call is waiting for an agent to become available, it is customary to play ‘comfort’ music or messages to the user. The ACD program module issues an invite to SVP 208. The invite contains the URL of a VXML script which either plays comfort music/messages to the customer, or provides additional self-service functionality while he is on hold.

CTI: When an agent comes available, the CTI program module handles the transfer of a call to an agent, while simultaneously initiating a new CRM session. The CTI program module uses the B2BUA to set up a connection from the customer to the agent's phone. At about the same time the CTI program module uses a pre-designated means to communicate to the CRM application that it should (a) start a new session, and (b) use data stored in the converged container to initialize the new CRM session. There are many viable choices available for how to start a new CRM session; for example the CTI logic can use SIP (or HTTP) messaging to send the URL of a page to an agent program running on the CRM's PC, which in turn starts a web browser session with that URL (many CRM applications use web browsers to present their GUIs).

Agent Transfer: While the agent is helping the customer he may determine that he needs to transfer the customer to another agent. For the purposes of our embodiment, the agent returns the call to the ACD program module with a request to re-queue the call for an appropriate agent or specialist. This request is sent over SIP or HTTP.

Today's call centers typically have remote agents that establish their own working schedule. Thus, the agent needs a mechanism to manage their availability to take call center calls. A conventional ACD 102 has a register of the available of agents to which it can route calls. The register is frequently updated—whenever an agent answers a call, he is no longer available until he completes that call and he has completed any “post-call” tasks. The CRM application's GUI or agent's telephone typically has a control which the agent uses to indicate to the ACD whether he is available or unavailable to take a call.

Center 200 uses the ACD 102 as well to provide agent availability. In particular, the ACD program module maintains a registry (database) of agents and pertinent data for each one, such as phone extension (or SIP address), desktop IP address, availability, and skill profile. The agent indicates his availability status through a control on his desktop (or a button on his phone), which uses HTTP (or SIP) messages to communicate to the ACD program module his availability. The ACD program module uses this to update the agent's registry entry. When the ACD program module wants to route a customer call to an agent, it searches the registry for an available agent (and may consider the available agents' skill profiles before selecting one to take the call). For sake of generality, since the ACD program module resides in a converged SIP/HTTP container, the communication of an agent's availability can be accomplished through SIP or HTTP messaging according to the actual of embodiment of the invention.

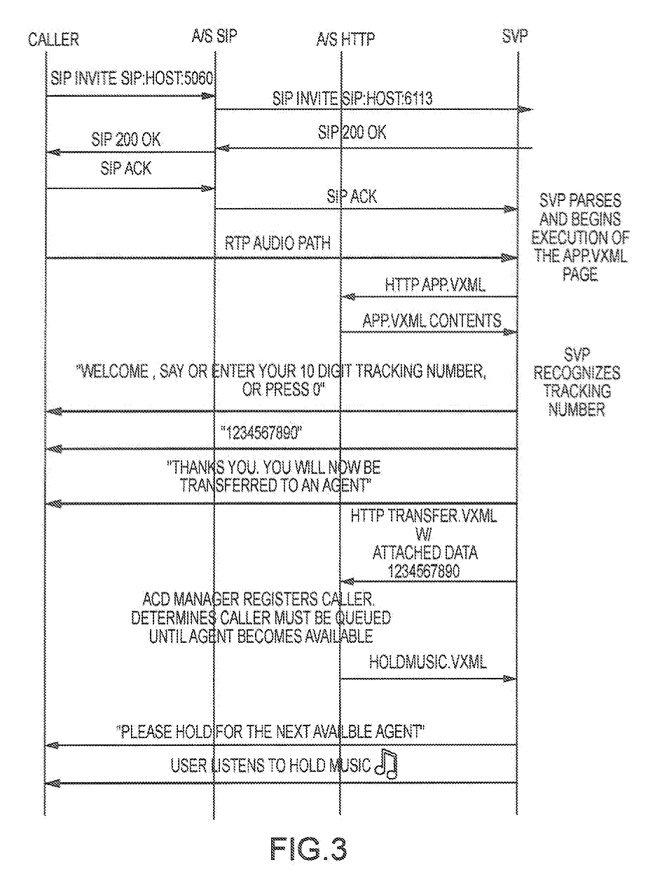

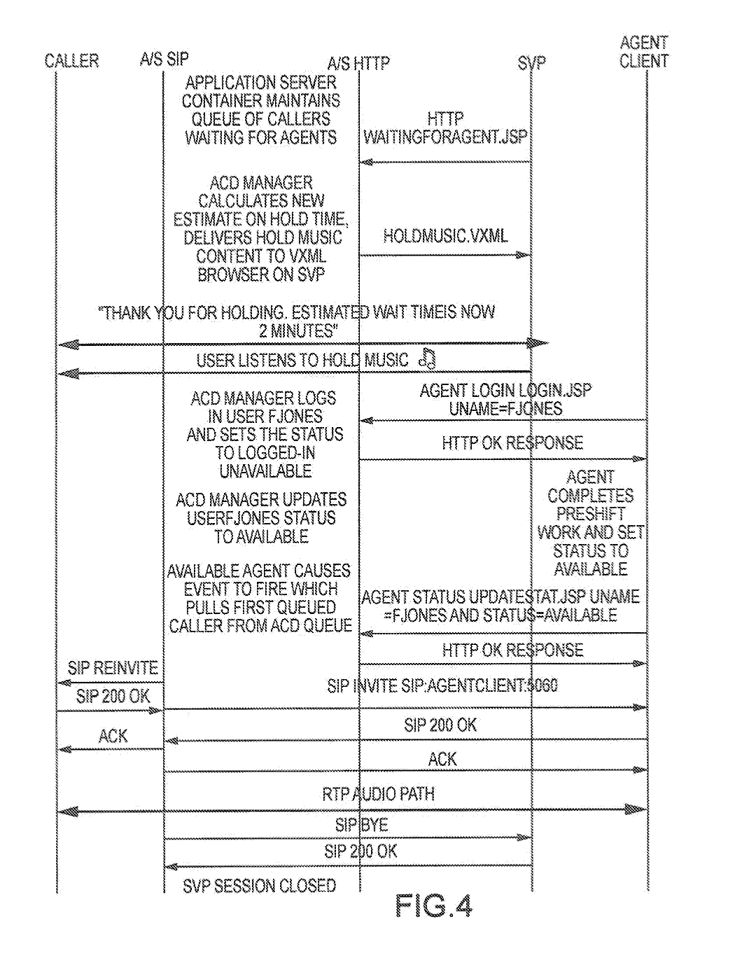

Finally, referring to FIGS. 3 and 4, sample call flow diagrams are provided for easy of understanding the system. These call flow diagrams are illustrative or some functionality of center 200 and should not be considered limiting in any way.

While the invention has been particularly shown and described with reference to an embodiment thereof, it will be understood by those skilled in the art that various other changes in the form and details may be made without departing from the spirit and scope of the invention.

What is claimed is:

1. A converged call center comprising:
a switch connectable to a telephony network to receive calls from a customer;
a converged container within an application server which supports call control signaling and hyper text transfer protocol (HTTP) coupled to the switch establishing a call control communication path between the switch and the converged container, wherein the call converged container contains at least one application;
a voice platform, the voice platform coupled to the switch to receive an audio signal from the switch, the voice platform coupled to the converged container; and
a customer service representative (CSR) workstation, the CSR workstation including a handset coupled to the switch to receive the audio signal from the switch and a control processor coupled to the voice platform and the converged container to receive application data from the at least one application and call control data from the converged container and application control from the voice platform.

2. The converged call center of claim 1, wherein the call control signal is a session initiation protocol (SIP) signal.

3. The converged call center of claim 1, wherein the at least one application contained in the converged container comprises a plurality of applications.

4. The converged call center of claim 3, wherein the plurality of applications comprises at least two applications selected from the group of applications consisting of: an automatic call distribution program (ACD), an interactive voice response application (IVR), a computer telephony integration application (CTI), and a customer relationship management application (CRM).

5. The converged call center of claim 4, wherein the converged container further comprising a back-to-back user agent to provide call control between the switch and the converged container.

6. The converged call center of claim 1, wherein the switch connects to a telephony network selected from the group of telephony networks consisting of: a public switched telephone network, a local area network, a wide area network, a WiFi network, the Internet, a wireless local area network, or a WiMax network.

7. The converged call center of claim 1, wherein the switch is a media gateway.

8. The converged call center of claim 1, wherein the handset is a VoIP enabled device.

9. The converged call center of claim 3, the plurality of applications communicate through the voice platform.

10. A method for processing a customer call at a converged call center comprising the steps of:
receiving a telephony call from a customer at a switch;
transmitting a call control invite to a converged container,
accepting the call control invite at the converged container by returning a call control acceptance to the switch;
initiating a call session;
retrieving customer data from an application in the converged container;
identifying a customer service representative (CSR) to accept the received telephony call from the customer;
providing an audio path from the customer to the CSR;
displaying customer data from the application in the converged container on the CSR monitor;
responding to the customer request; and
terminating the call session.

11. The method of claim 10, wherein the switch to receive the telephony call is a media gateway.

12. The method of claim 10, further comprising the step of queuing the received telephony call until the CSR is available to accept the call.

13. The method of claim 10, wherein the application comprises a plurality of applications.

14. The method of claim 13, wherein the plurality of applications includes at least two applications selected from the group of applications consisting of: ACD, IVR, CTI, and CRM.

15. The method of claim 12, further comprising an application to play an on hold message until the CSR is available.

16. The method of claim 12, further comprising the step of transmitting a call control invite to the next available CSR agent and transferring the call to the CSR agent on receipt of a call control acceptance.

17. The method of claim 13, wherein the plurality of applications interact through the voice platform by a first application sending call control requests to a second application for data processing, receiving call control acceptance from the second application at the first application for data processing, establishing a communication path between the first application and the second application, transmitting data to the second application for data processing on receiving call control acceptance, and returning the processed data from the second application to the first application.

18. The method of claim 17, wherein the interaction between the first application and the second application terminates on returning the processed data.
